(19) United States
(12) Patent Application Publication
(10) Pub. No.: US 2017/0210105 A1
(43) Pub. Date: Jul. 27, 2017

(54) BIAXIALLY-STRETCHED LAYER POLYAMIDE FILM AND PACKAGING BAG

(71) Applicant: TOYOBO CO., LTD., Osaka-shi, Osaka (JP)

(72) Inventors: Takuro ENDO, Inuyama-shi, Aichi (JP); Tomoki ITO, Inuyama-shi, Aichi (JP)

(73) Assignee: TOYOBO CO., LTD., Osaka-shi, Osaka (JP)

(21) Appl. No.: 15/326,085

(22) PCT Filed: Jun. 15, 2015
(86) PCT No.: PCT/JP2015/067176

§ 371 Date: Jan. 13, 2017

(30) Foreign Application Priority Data
Jul. 14, 2014 (JP) 2014-144281

(51) Int. Cl. B32B 27/34; B32B 27/32; B65D 65/40; B32B 7/02

(52) U.S. Cl. CPC B32B 27/34; B32B 7/02; B32B 27/32; B65D 65/40; B32B 2307/518; B32B 2307/736; B32B 2309/105

(57) ABSTRACT

The present invention is to provide a biaxially-stretched layer polyamide film which is excellent in bag breakage resistance, impact resistance and bending fatigue resistance, particularly in bending fatigue resistance under low-temperature environments, is excellent in an effect such as bag breakage prevention during transportation or storage of products when used as a packaging material for packaging foods or the like, can exhibit both high heat seal strength and good appearance even when being automatically filled with a liquid soup, a seasoning agent, or the like at a high speed, and further has improved volume reduction performance and environmental friendliness as compared with conventional polyamide films, and is thus suitable for various packaging applications, particularly for packaging bags for filling liquid materials such as soup and sauce. The biaxially-stretched layer polyamide film comprising: an A layer of a mixed polymer containing 97 to 70 wt. % of an aliphatic homopolyamide, 3 to 20 wt. % of an aliphatic copolyamide, and 0 to 10 wt. % of a thermoplastic elastomer, and a B layer of a mixed polymer containing 99.5 to 90 wt. % of an aliphatic homopolyamide and 0.5 to 10.0 wt. % of a thermoplastic elastomer, the B layer being layered on at least one surface of the A layer, and a film thickness of less than 9 μm.

### TECHNICAL FIELD

The present invention relates to a biaxially-stretched layer polyamide film which is excellent in impact resistance and bending fatigue resistance, particularly in bending fatigue resistance under low-temperature environments, is effective in bag breakage prevention during transportation or storage of products when used as a packaging material for packaging foods or the like, can sufficiently maintain its strength even when thinned, and can exhibit both high heat seal strength and good appearance even when being automatically filled with a liquid soup, a seasoning agent, or the like at a high speed, and is thus suitable for various packaging applications, and also relates to a packaging bag.

### BACKGROUND ART

Conventionally, unstretched films and stretched films made of aliphatic polyamides represented by nylon 6 and nylon 66 are excellent in impact resistance and bending fatigue resistance, and have been widely used as various kinds of packaging material films. Additionally, to further improve the bending fatigue resistance and impact resistance for filling and packaging a liquid such as soup, a seasoning agent, or the like in the film, stretched polyamide films for pinhole resistance, that is made softer by mixing various kinds of elastomers (rubber components) with aliphatic polyamides in a monolayer structure, have been widely used.

A film obtained by mixing a polyamide-based elastomer with an aliphatic polyamide is known among films for pinhole resistance (Patent Document 1). This film has good bending fatigue resistance and impact resistance under low-temperature environments, and scarcely generates pinholes due to bending fatigue under low-temperature environments.

Further, properties such as the bending fatigue resistance and impact resistance can be improved by making a polyamide film have a layered structure. For example, a biaxially-stretched layer polyamide film including a layer of an aliphatic polyamide containing an aliphatic homopolyamide and a thermoplastic elastomer and a layer of an aliphatic polyamide containing a thermoplastic elastomer and inorganic particles is disclosed (Patent Document 2). This biaxially-stretched layer polyamide film has properties that the bending fatigue resistance and impact resistance under low-temperature environments are good and that pinholes due to bending fatigue are scarcely generated even under low-temperature environments. However, further improved bending fatigue resistance and impact resistance have been required in recent years, and particularly, in the case where a film is thinned to have a film thickness of not more than 9 μm, the properties required such as impact resistance and pinhole resistance cannot be satisfied sufficiently.

On the other hand, when a polyamide film is used as a packaging bag, an adhesive layer is formed on at least one surface as required, and a sealant layer made of polyethylene, polypropylene, or the like is formed on the adhesive layer by a dry lamination method or an extrusion lamination method. Then, the film is formed into a bag by a generally known method and contents such as soup, a seasoning agent, or the like are filled into the bag through an opening, and thereafter the opening is sealed by heat. In this case, packaging of a product by using an automatic filling machine is excellent in convenience and productivity, and has been widely employed for packaging various kinds of products including foods and beverages.

As for such an automatic filling machine, improvements in speed and efficiency have recently been promoted with the aim of further improving productivity. At the time of automatically filling various kinds of products at a high speed or forming a bag, it is necessary to set a high heat sealing temperature in order to obtain a sufficient seal strength. However, there is a problem that the film is shrunk due to heat sealing at a high temperature to generate wavy wrinkles in the heat-sealed parts. Such wavy wrinkle generation in the heat-sealed parts not only lowers the product value in terms of the appearance but also leads to content leakage or bag breakage. On the other hand, if the heat sealing temperature is lowered to prevent wrinkle generation in the heat-sealed parts, unbonded parts are generated in the heat-sealed parts to lower the seal strength and lead to content leakage.

To solve these problems, a polyamide film with prescribed heat shrinkage rate is disclosed (Patent Document 3). However, in the invention of the polyamide film, there is no description of improvement of the bending fatigue resistance, impact resistance, and the like, which are important required properties when the film is used as a packaging material.

As described above, when a polyamide film is used as a liquid packaging bag for soup, a seasoning agent, or the like, high seal strength after heat sealing and good appearance property in heat-sealed parts are required besides the bending fatigue resistance and impact resistance. However, no conventional film configuration can satisfy all of the required properties.

Further, as part of countermeasures for environmental issues in recent years, saving resources and reducing wastes are required, and it is also necessary to promote reduction of the volume of liquid filling/packaging materials.

### PRIOR ART DOCUMENT

### Patent Documents

Patent Document 1: JP-A-Hei-11-254615

Patent Document 2: JP-A-2010-234552

Patent Document 3: JP-A-Hei-11-277698

### SUMMARY OF THE INVENTION

### Problems to be Solved by the Invention

The present invention has been made in view of the above-mentioned problems of the conventional polyamide films for pinhole resistance, and an object of the present invention is to provide a biaxially-stretched layer polyamide film which is excellent in bag breakage resistance, impact resistance and bending fatigue resistance, particularly in bending fatigue resistance under low-temperature environments, is excellent in an effect such as bag breakage prevention during transportation or storage of products when used as a packaging material for packaging foods or the like, can exhibit both high heat seal strength and good appearance even when being automatically filled with a liquid soup, a seasoning agent, or the like at a high speed, and further has improved volume reduction performance and environmental friendliness as compared with conventional polyamide films, and is thus suitable for various packaging applications, particularly for packaging bags for filling liquid materials such as soup and sauce.

### Solutions to the Problems

The inventors of the present invention considered and made investigations on the issue of the film thickness of a polyamide film to satisfy bending fatigue resistance and both of heat seal strength and good appearance at the time of automatic filling, and consequently found that it is possible to satisfy all of these properties, which were conventionally impossible, by making a biaxially-stretched layer polyamide film, that includes a layer containing an aliphatic homopolyamide, an aliphatic copolyamide, and a thermoplastic elastomer and a layer containing an aliphatic homopolyamide and a thermoplastic elastomer, have a thickness not more than a specified thickness, and the finding has now lead to completion of the present invention.

That is, the present invention has the following configuration.

1. A biaxially-stretched layer polyamide film having a heat shrinkage rate of 1.5% to 4.0% in a vertical direction and a heat shrinkage rate of 2.1 to 4.5% in a transverse direction when kept under dry heating at 160° C. for 10 minutes, a film thickness of less than 9 μm, and an elastic modulus of not more than 2.2 GPa.

2. The biaxially-stretched layer polyamide film according to 1., wherein a value calculated by dividing a heat shrinkage rate in a film width direction by a heat shrinkage rate in a film flow direction when the film is kept under dry heating at 160° C. for 10 minutes is 1.0 to 1.4.

3. The biaxially-stretched layer polyamide film according to 1. or 2., comprising: an A layer of a mixed polymer containing 97 to 70 wt. % of an aliphatic homopolyamide, 3 to 20 wt. % of an aliphatic copolyamide, and 0 to 10 wt. % of a thermoplastic elastomer, and a B layer of a mixed polymer containing 99.5 to 90 wt. % of an aliphatic homopolyamide and 0.5 to 10.0 wt. % of a thermoplastic elastomer, the B layer being layered on at least one surface of the A layer.

4. The biaxially-stretched layer polyamide film according to any one of 1. to 3., wherein the thermoplastic elastomer constituting the A layer is at least one elastomer selected from the group consisting of polyamide-based elastomers, polyolefin-based elastomers, and ionomers.

5. The biaxially-stretched layer polyamide film according to any one of 1. to 4., wherein the B layer has a thickness of not less than 1 μm.

6. The biaxially-stretched layer polyamide film according to any one of 1. to 5., wherein the film has an impact strength of not less than 0.6 J/10 μm, a number of bending fatigue pinholes at 5° C. of not more than 5, and a breaking strength of not less than 200 MPa.

7. The biaxially-stretched layer polyamide film according to any one of 1. to 6., wherein the B layer contains 0.005 to 0.5 wt. % of inorganic fine particles having a fine pore volume of 0.6 to 1.0 ml/g and 0.01 to 2.0 wt. % of inorganic fine particles having a fine pore volume of 1.1 to 1.6 ml/g, and the inorganic fine particles have an average particle diameter of 0.5 to 5.0 μm.

8. The biaxially-stretched layer polyamide film according to any one of 1. to 7., wherein the A layer and/or the B layer contains 0.01 to 0.40 wt. % of an aliphatic acid amide and/or an aliphatic acid bisamide.

9. The biaxially-stretched layer polyamide film according to any one of 1. to 9., wherein the film has a static friction coefficient between easily slipping surfaces of the film at 23° C. and 65% RH of not more than 0.90.

10. A packaging bag, comprising the biaxially-stretched layer polyamide film according to 1. to 9. with a B layer as an outermost layer.

### Effects of the Invention

The present invention can provide a polyamide film excellent in high heat seal strength and appearance property even when used for automatic filling at a high speed, and can be reduced in volume while maintaining toughness, pinhole resistance, and bending resistance which are properties of a polyamide film.

### MODE FOR CARRYING OUT THE INVENTION

Hereinafter, a biaxially-stretched layer polyamide film of the present invention will be described in detail. The biaxially-stretched layer polyamide film of the present invention includes an A layer containing a particular mixed polymer and a B layer containing a particular mixed polymer layered on at least one surface of the A layer.

The A layer of the present invention contains a mixed polymer of 97 to 70 wt. % of an aliphatic homopolyamide, 3 to 20 wt. % of an aliphatic copolyamide, and, optionally, 0 to 10 wt. % of a thermoplastic elastomer. Since the A layer has a structure in which the aliphatic copolyamide is micro-dispersed as a flexibility-imparting agent and a viscosity-imparting agent in the aliphatic homopolyamide excellent in impact resistance and bending fatigue resistance, the A layer can contribute to improvement of excellent impact strength and bending fatigue resistance. Since the A layer has a structure in which the thermoplastic elastomer is dispersed as a pinhole-resistant material, the A layer can contribute to improvement of further excellent bending fatigue resistance, particularly to improvement of the bending fatigue resistance under low-temperature environments. Herein, if the mixed amount of the aliphatic copolyamide forming the A layer is less than 3 wt. % and if the mixed amount of the thermoplastic elastomer is small, it is impossible to obtain the required high impact resistance and high bending fatigue resistance better than those of a presently available polyamide stretched film with pinhole resistance. Further, if the mixed amount of the aliphatic copolyamide forming the A layer exceeds 20 wt. %, impact strength and bending fatigue resistance are saturated. Still further, if the mixed amount of the thermoplastic elastomer is increased, the effect of improving bending fatigue resistance can be caused, but if the mixed amount exceeds 10 wt. %, transparency is deteriorated and bending fatigue resistance is saturated.

As the aliphatic homopolyamide forming the A layer of the present invention, those which are usable as a film-forming material and proper to form the above-mentioned structure can be used without any particular limitation. For example, aliphatic polyamide homopolymers such as nylon 6, nylon 6,6, nylon 11, nylon 12, and nylon 6,10 may be used.

As the aliphatic copolyamide to be added to the A layer, usable are copolymers of not more than 10 wt. %, preferably 1 to 10 wt. %, of monomers copolymerizable with the above-mentioned aliphatic homopolyamide, for example, aliphatic copolyamides such as a nylon 6/6,6 copolymer, a nylon 6/12 copolymer, a nylon 6/6,10 copolymer, and a nylon 6,6/6,10 copolymer; polyamide copolymers that contain ε-caprolactam as a main component, that are obtained by copolymerizing the main component with a nylon salt of hexamethylenediamine and isophthalic acid and a nylon salt of metaxylylenediamine and adipic acid, and that contain a small amount of aromatics; or the like.

The thermoplastic elastomer to be added to the A layer means a thermoplastic material as a substance having rubber elasticity, and is not particularly limited as long as it is proper to form the above-mentioned structure. Examples of the thermoplastic elastomer include polyamide-based elastomers, polyolefin-based elastomers, polystyrene-based elastomers, polyurethane-based elastomers, polyester-based elastomers, poly(vinyl chloride)-based elastomers, ionomer polymers, and mixtures of these elastomers. The thermoplastic elastomer may be used alone or in combination of 2 or more kinds.

In the present invention, the thermoplastic elastomer may be reformed as long as the object of the present invention is not adversely affected. For example, modified products of the above-exemplified thermoplastic elastomers may be used. Examples of reforming of a thermoplastic elastomer may include reforming by copolymerization and graft modification, and reforming by addition of polar groups. Addition of polar groups may be carried out by graft modification. Examples of the polar groups may include an epoxy group, a carboxyl group, an acid anhydride group, a hydroxyl group, an amino group, and an oxo group. One kind or a combination of a plurality of kinds of polar groups may be added. Consequently, examples of modified products having polar groups may include epoxy modified products, carboxy modified products, acid anhydride modified products, hydroxy modified products, and amino modified products of thermoplastic elastomers.

Those preferably usable as the thermoplastic elastomer of the present invention are polyamide-based elastomers, polyolefin-based elastomers, and ionomer polymers.

Examples of the polyamide-based elastomers may include polyamide-based block copolymers including a hard segment containing a polyamide component and a soft segment containing a polyoxyalkylene glycol component. The polyamide component of the hard segment may be selected from the group consisting of (1) lactams, (2) ω-amino-aliphatic carboxylic acids, (3) aliphatic diamines and aliphatic dicarboxylic acids, and (4) aliphatic diamines and aromatic dicarboxylic acids, and specific examples of the polyamide component may include lactams such as ε-caprolactam, aliphatic diamines such as aminoheptanoic acid, aliphatic dicarboxylic acids such as adipic acid, and aromatic dicarboxylic acids such as terephthalic acid. Examples of polyoxyalkylene glycol constituting the soft segment of the polyamide-based block copolymers may include polyoxytetramethylene glycol, polyoxyethylene glycol, and polyoxy-1,2-propylene glycol.

The melting point of a polyamide-based block copolymer is determined by the types and ratio of the hard segment formed from the polyamide component and of the soft segment formed from the polyoxyalkylene glycol component, and generally, those having a melting point in the range from 120° C. to 180° C. may be used.

Use of a polyamide-based block copolymer as a constituent component of the biaxially-stretched layer polyamide film is effective for improving the bending fatigue resistance of the biaxially-stretched layer polyamide film, particularly the bending fatigue resistance under low-temperature environments.

Further, polyolefin-based elastomers are not particularly limited, and may be block copolymers containing polyolefins as a hard segment and various kinds of rubber components as a soft segment. Examples of the polyolefins forming a hard segment may include homopolymers or copolymers of α-olefins having around 2 to 20 carbon atoms, such as ethylene, propylene, 1-butene, 1-pentene, 4-methyl-1-pentene, 3-methyl-1-pentene, 1-octene, 1-decene, 1-dodecene, 1-tetradecene, 1-hexadecene, and 1-octadecene. Polyolefins may be used alone or in combination of 2 or more kinds. Preferable olefins may include ethylene and propylene. Further, examples of the rubber component constituting the soft segment may include ethylene-propylene rubber (EPR), ethylene-propylene-diene rubber (EPDM), polybutadiene, polyisoprene, natural rubber (NR), nitrile rubber (NBR; acrylonitrile-butadiene rubber), styrene-butadiene rubber (SBR), chloroprene rubber (CR), butyl rubber (IIR), hydrogenated NBR (H-NBR), acrylonitrile-isoprene rubber (NIR), and acrylonitrile-isoprene-butadiene rubber (NBIR). These rubber components include acid-modified rubbers such as carboxylated rubber containing, as a comonomer, an unsaturated carboxylic acid such as acrylic acid, methacrylic acid, maleic acid, and maleic anhydride, other modified rubbers, and hydrogenated products. These rubber components may be used alone or in combination of 2 or more kinds.

Further, ionomer polymers are not particularly limited, and may be block copolymers containing polyolefins as a hard segment and various kinds of rubber components acid-modified with an unsaturated carboxylic acid as a soft segment, and neutralized with metal ions. Preferable ionomer polymers are copolymer resins formed of ethylene and methacrylic acid, or ionomer polymers obtained by neutralizing copolymer resins formed of ethylene, methacrylic acid, and an acrylic acid ester with metal ions including Na⁺, K⁺, and Zn²⁺.

The mixed polymer forming the A layer may be a polymer obtained by mixing the above-mentioned aliphatic homopolyamide and aliphatic copolyamide, which are virgin raw materials, and optionally a thermoplastic elastomer, or a polymer obtained by adding waste materials generated as nonstandard films or chipped offcut materials (trimming scrap) at the time of producing the biaxially-stretched layer polyamide film of the present invention, their regenerated resins, and virgin raw materials.

The B layer of the present invention contains a mixed polymer of 99.5 to 90 wt. % of an aliphatic homopolyamide and 0.5 to 10 wt. % of a thermoplastic elastomer. The B layer has excellent bending pinhole resistance, stands the impact of the bending applied to packaging bags, and contributes to exhibition of the bag breakage prevention. If the content of the thermoplastic elastomer is within the above-mentioned range, the bending fatigue resistance can be improved together with good transparency.

The above-mentioned aliphatic homopolyamides and thermoplastic elastomers of the A layer may be used similarly for the aliphatic homopolyamide and thermoplastic elastomer forming the B layer.

In the above-described manner, a polyamide resin film to be used for the present invention can be formed. Herein, the bending fatigue of a film is affected by the film thickness, and is lowered as the film is thicker. This is because when a film is bent, tensile stress is applied to the outside of the bending and compressive stress is applied to the inside of the bending, and these stresses increase as the film thickness increases. The polyamide film obtained in the present invention preferably has a thickness of less than 9 μm. If the film thickness is not less than 9 μm, the bending fatigue resistance is lowered and therefore, it is not preferable.

The thickness of the polyamide film considerably affects heat seal strength and film appearance after automatic filling at a high speed. The reason is as follows: after the polyamide film is subjected to formation of a sealant layer containing polyethylene or polypropylene and processed into a bag, the bag is filled with contents such as a seasoning agent and heat-sealed at the opening with the sealant layer inside, and in the case where the polyamide film is thick, heat is not sufficiently transmitted to the heat seal layer, which is formed in the inner side of the polyamide film, at the time of automatic filling at a high speed to lower the heat seal strength. On the other hand, when the heat sealing temperature is made high at the time of automatic filling at a high speed, although a sufficient heat seal strength is obtained, wavy wrinkles are generated in the heat-sealed parts and the appearance is deteriorated due to heating of the film at a high temperature.

It is important to adjust the film thickness to be less than 9 μm in order to satisfy both of the heat seal strength at the time of automatic filling at a high speed and the good film appearance. In the case where the film thickness is not less than 9 μm, it is difficult to simultaneously satisfy these two properties, and in the case where the heat sealing temperature at the time of automatic filling at a high speed is made low, the heat seal strength becomes insufficient. On the other hand, in the case where the heat sealing temperature is made high to obtain sufficient heat seal strength, wrinkles are generated in the heat-sealed parts and it leads to a problem of deterioration of appearance.

Further, by adjusting the film thickness to be less than 9 μm, the volume is reduced as compared with that of polyamide films conventionally used for packaging applications, and it is possible to satisfy requirements of saving resources and reducing wastes, which are a part of countermeasures for environmental issues.

As described above, adjustment of the film thickness to be less than 9 μm makes it possible to simultaneously satisfy the bending fatigue resistance, heat seal strength, and good appearance after heat sealing, and further to reduce the volume.

A method for measuring the heat seal strength will be described later, and it is preferable that the seal strength measured according to JIS Z1707 is not less than 23 N/15 mm in the case where the polyamide film of the present invention is subjected to formation of a sealant layer containing polyethylene or polypropylene and processed into a bag, and thereafter the opening is heat-sealed with the sealant layer inside. In the case where the seal strength is lower than 23 N/15 mm, unbonded parts are generated in the heat-sealed parts, and the parts may possibly cause a problem of leakage of contents and therefore, it is not preferable.

Even if the biaxially-stretched layer polyamide film of the present invention including the B layer configured as described above layered on at least one surface (e.g., one surface or both surfaces) of the A layer configured as described above is extremely thin so that the film has a total film thickness of less than 9 μm, the impact strength can be not less than 0.6 J/10 μm, the number of bending fatigue pinholes at 5° C. can be not more than 5, and the breaking strength can be not less than 200 MPa. Further, the biaxially-stretched layer polyamide film of the present invention preferably has a haze of not more than 6%. If the haze exceeds 6%, transparency cannot be improved sufficiently, and the film is hardly usable for applications for which transparency is required. The haze is more preferably not more than 5%, further preferably not more than 4%. The haze value is preferably as small as possible, but it may be not less than 1%. Even a haze value of not less than 2% can be said to be within a preferable range.

Further, the above-mentioned stretched polyamide film preferably has a heat shrinkage rate of 1.5% to 4.0% in the film flow direction (vertical direction) and a heat shrinkage rate of 2.1 to 4.5% in the film width direction (transverse direction) when kept under dry heating at 160° C. for 10 minutes. If the heat shrinkage rate in the vertical direction and in the transverse direction exceeds 4.0% and 4.5%, respectively, the film undergoes heat hysteresis at the time of heat sealing, and shrinkage wrinkles tend to be generated due to heat shrinkage rate and it is not preferable. Further, in steps for processing such as printing, and laminating on another substrate film, undesirable phenomena such as pitch deviation in printing and a curling phenomenon occur due to heat shrinkage rate. On the other hand, if the heat shrinkage rate in the flow direction is smaller than 1.5%, the tensile strength of the polyamide-based resin film layer becomes insufficient and the film is stretched when the film is rubbed with a heating roll during heat sealing, and therefore wavy wrinkles are undesirably generated in the heat-sealed parts.

To prevent wavy wrinkle generation in heat-sealed parts, the balance between the heat shrinkage rate in the vertical direction and the heat shrinkage rate in the transverse direction is important. For example, in the case where heat sealing is carried out in the transverse direction in a state where the heat shrinkage rate in the vertical direction is not less than 2.5% and tensile force is exhibited against rubbing in the vertical direction, shrinkage occurs in the transverse direction, and in the case where the heat shrinkage rate in the transverse direction is less than 1.5%, the shrinkage cannot be absorbed to generate wavy wrinkles in the heat-sealed parts.

From the matters as described above, the range from 1.5 to 4.0% of the heat shrinkage rate in the film flow direction (vertical direction) and the range from 2.1 to 4.5% of the heat shrinkage rate in the width direction (transverse direction) have to be simultaneously satisfied, and the value calculated by dividing the heat shrinkage rate in the film width direction by the heat shrinkage rate in the film flow direction when the film is kept under dry heating at 160° C. for 10 minutes is preferably 1.0 to 2.0, more preferably 1.0 to 1.4. As this value is closer to 1.0, the shrinkage factor in the film flow direction and that in the film width direction come closer to make wrinkle generation difficult, and the film appearance is improved.

Further, the biaxially-stretched layer polyamide film of the present invention preferably has an elastic modulus of not more than 2.2 GPa. If the elastic modulus is higher than 2.2 GPa, the flexibility of the film is insufficient and the bending fatigue resistance is lowered. If the elastic modulus is lower than 1.5 GPa, the film is too flexible and loses the balance with the pinhole resistance. The elastic modulus is more preferably not less than 1.6 GPa and not more than 2.1 GPa.

It is necessary to optimize heat fixation temperature and time in a tenter in the film formation process in order to satisfy both the elastic modulus and other physical properties simultaneously. The heat fixation temperature is preferably 190° C. to 205° C., more preferably 195° C. to 203° C. The heat fixation time is preferably 5 to 20 seconds, more preferably 10 to 15 seconds. Particularly, if the heat fixation temperature is lower than 190° C., film crystallization is not promoted so that the structure cannot be stabilized, and the dimensional stability may be deteriorated and intended properties such as heat shrinkage rate cannot be obtained. Further, the mechanical strengths such as impact resistance and pinhole resistance are also insufficient.

On the other hand, in the case where the heat fixation temperature is higher than 205° C., crystallization of the film proceeds too much and the required elastic modulus cannot be obtained and therefore, it is not preferable. Further, due to the crystallization, the film is whitened and devitrified, and thus haze tends to be increased easily.

Still further, the biaxially-stretched layer polyamide film of the present invention preferably contains inorganic fine particles having 2 or more kinds of fine pore volumes, such as inorganic fine particles having a fine pore volume of 0.6 to 1.0 ml/g and inorganic fine particles having a fine pore volume of 1.1 to 1.6 ml/g in the B layer. The range of the fine pore volume of the inorganic fine particles is preferably 0.5 to 2.0 ml/g, more preferably 0.8 to 1.5 ml/g. If the fine pore volume is less than 0.5 ml/g, voids tend to be generated easily and the transparency of the film is deteriorated, and if the fine pore volume exceeds 2.0 ml/g, the slipperiness of the film is deteriorated and therefore, it is not preferable. Use of inorganic fine particles having 2 or more kinds of fine pore volumes as described above makes it possible to keep the transparency and excellent slipperiness even under highly humid environments, to absorb friction and bending impact applied to a packaging bag, and to contribute to exhibition of bag breakage resistance.

The inorganic particles may be properly selected from inorganic lubricants such as silica, kaoline, and zeolite, and polymer-based organic lubricants such as an acrylic lubricant and a polystyrene lubricant. Silica fine particles are preferably used in terms of the transparency and slipperiness.

The average particle diameter of the inorganic fine particles is preferably 0.5 to 5.0 μm, more preferably 1.0 to 3.0 μm. If the average particle diameter is less than 0.5 μm, a large amount of addition is required to obtain good slipperiness, and if it exceeds 5.0 μm, the surface roughness of the film is too significant to satisfy properties for practical use, and therefore, it is not preferable.

The fine pore volume means the volume (ml/g) of the fine pores contained in 1 g of inorganic fine particles. Silica fine particles having such a fine pore volume can be obtained generally by pulverizing and classifying synthetic silica, and it is also possible to use porous silica fine particles obtained as spherical fine particles directly at the time of synthesis. Further, such silica fine particles are agglomerates of primary particles, and voids among primary particles form the fine pores.

The fine pore volume can be adjusted by changing the conditions for synthesizing inorganic fine particles, and as the fine pore volume is smaller, better slipperiness can be provided with a small addition amount. Although use of inorganic fine particles having a small fine pore volume results in formation of high projections on the film surface in a step of stretching the added polyamide-based resin, such use generates a large number of voids to deteriorate transparency of the film in some cases. Contrarily to that, use of inorganic fine particles having a large fine pore volume makes large quantity addition possible while maintaining transparency. However, the height of the surface projections formed is low, and large quantity addition of inorganic fine particles is required to maintain the preferable slipperiness even under highly humid conditions. Consequently, addition of the above-mentioned inorganic fine particles having 2 or more kinds of ranges of fine pore volumes enables coexistence of high surface projections and low surface projections, and can provide slipperiness even under highly humid conditions while maintaining the transparency. The transparency of a biaxially-stretched film may change depending on the stretching conditions (temperature and ratio) or relaxing treatment conditions (relaxing ratio and temperature) carried out thereafter and therefore, it is desirable to properly control these conditions.

A method for adding inorganic fine particles to the B layer may be a conventionally known method, such as a method including adding the inorganic fine particles at the time of resin polymerization or adding the inorganic fine particles at the time of melt extrusion by an extruder to obtain a master batch, and adding this master batch to polyamides at the time of film production.

The average particle diameter of inorganic fine particles is a value measured as follows. Inorganic fine particles are dispersed in ion-exchanged water stirred at a prescribed rotating speed (about 5000 rpm) using a high speed stirrer, and the resulting dispersion is added to Isoton (physiological saline solution) and further dispersed by an ultrasonic dispersing machine, and thereafter subjected to particle size distribution measurement by a Coulter counter method. The particle diameter at 50% of the weight accumulation distribution is determined as the average particle diameter.

The content of the inorganic fine particles in the B layer is 0.03 to 2.5 wt. %, more preferably 0.08 to 1.5 wt. %. If the content of the inorganic fine particles is less than the above-mentioned range, slipperiness of the biaxially-stretched film under high humidity cannot be sufficiently improved, and if the content exceeds the above-mentioned range, the amount of loss in the extraction step increases, and the transparency of the film is deteriorated beyond an allowable extent and therefore, it is not preferable. Inorganic fine particles having a fine pore volume of 0.6 to 1.0 ml/g and inorganic fine particles having a fine pore volume of 1.1 to 1.6 ml/g are preferably contained in the B layer in an amount of 0.005 to 0.5 wt. % and 0.01 to 2.0 wt. %, respectively.

The biaxially-stretched layer polyamide film of the present invention may contain, besides the above-mentioned indispensable components, various kinds of additives, for example, a lubricant, an anti-blocking agent, a heat stabilizer, an antioxidant, an antistatic agent, a lightfast agent, and an impact modifier as long as the above-mentioned properties are not inhibited. Particularly, when an organic lubricant which is effective for lowering the surface energy is added to such an extent that no problem is caused on the adhesiveness and wettability, the stretched film is provided with further excellent slipperiness and transparency and therefore, it is preferable.

In the present invention, it is possible to add an aliphatic acid amide and/or an aliphatic acid bisamide in the A layer and/or the B layer for the purpose of giving slipperiness to the biaxially-stretched layer polyamide film. Examples of the aliphatic acid amide and/or aliphatic acid bisamide may include erucic acid amide, stearic acid amide, ethylene bisstearic acid amide, and ethylene bisoleic acid amide.

In this case, the content of the aliphatic acid amide and/or aliphatic acid bisamide in the polyamide is preferably 0.01 to 0.40 wt. %, further preferably 0.05 to 0.2 wt. %. If the content of the aliphatic acid amide and/or aliphatic acid bisamide is less than the above-mentioned range, the slipperiness is deteriorated, and processing suitability for printing or laminating is deteriorated and if the content exceeds the above-mentioned range, bleeding to the film surface may occur with the lapse of time to generate spots on the film surface, and therefore, it is not preferable in terms of the quality.

The biaxially-stretched layer polyamide film of the present invention may achieve a static friction coefficient between easily slipping surfaces of films at 23° C. and 65% RH of not more than 0.90 by adding inorganic fine particles to the B layer or making the A layer and/or the B layer contain the aliphatic acid amide and/or aliphatic acid bisamide. Herein, easily slipping surfaces of the film mean the layer containing inorganic fine particles, that is, the B layer.

The total thickness of the biaxially-stretched layer polyamide film of the present invention is not particularly limited, but is usually not more than 100 μm in the case where the film is used as a packaging material, and generally those having a thickness of 5 to 50 μm may be used. However, the biaxially-stretched layer polyamide film of the present invention can exhibit the above-mentioned effect even in the case of having a small film thickness of less than 9 μm.

The biaxially-stretched layer polyamide film of the present invention, when being processed into a packaging bag (bagged product), preferably has a laminate configuration in which the B layer surface serves as the outermost surface of a bagged product. In the case where the bagged product generates friction with a transporting package of corrugated cardboard or the like at the time of transportation, the film may possibly be abraded to break the bag due to the friction, or bags may stick one another due to contact or broken due to increase of bending fatigue or the like. In the configuration of the present invention, the B layer with good slipperiness can lessen the cause of bag breakage due to friction, and exhibits high bag breakage resistance.

In this case, when the thickness of the B layer occupies a large portion of the total film thickness, the transparency is considerably lowered although the high slipperiness is guaranteed. Contrarily, when the thickness of the A layer occupies almost all of the total film thickness, the slipperiness cannot be guaranteed although the film is excellent in flexibility, impact strength, and bending fatigue resistance. Consequently, in the present invention, the thickness of the A layer is preferably 60 to 96%, particularly 65 to 93% of the total thickness of the A layer and the B layer. Further, control of the thickness of the B layer to be at least 1 μm, preferably not more than 3 μm makes it possible to effectively exhibit both of the bending fatigue resistance and wear resistance.

A method for mixing various kinds of polyamides, thermoplastic elastomers, and the like constituting the A layer and the B layer is not particularly limited, but a method generally used is a method including mixing polymers in form of chips by using a V-shape blender and thereafter melting and forming the resulting mixture.

The polyamide constituting the A layer and the B layer of the biaxially-stretched layer polyamide film of the present invention may contain, as required, other thermoplastic resins, for example, polyester-based polymers such as poly(ethylene terephthalate), poly(butylene terephthalate), and poly(ethylene-2,6-naphthalate), and polyolefin-based polymers such as polyethylene and polypropylene as long as the properties of the polyamide are not disturbed.

Further, as required, various kinds of additives such as an antistatic agent, an anti-fogging agent, an ultraviolet absorbent, a dye, and a pigment may be added to one or both of the layers, that is, the A layer and/or the B layer formed of the polyamide.

The biaxially-stretched layer polyamide film of the present invention can be produced by a conventionally known production method. Employable as the method are, for example, any conventionally known methods such as a production method by melting polymers constituting the layers by using different extruders and co-extruding the polymers from one die; a production method by separately melt-extruding polymers constituting the layers in a film form, and thereafter laminating the layers in a laminate manner; and a method employing the foregoing in combination. A conventionally known method, for example, a flat type successive biaxial stretching method, a flat type simultaneous biaxial stretching method, or a tubular method is used to stretch the film 2 to 5 times in the vertical direction and 3 to 6 times in the transverse direction and, as required, heat fixation may be carried out. As a result, transparency, oxygen gas barrier property, and processing suitability of the layered film can be improved.

The biaxially-stretched layer polyamide film of the present invention may be used to form a packaging bag. The packaging bag may be formed by further laminating a sealant layer on the biaxially-stretched layer polyamide film and heat-sealing the sealant layer itself. As a heat sealable resin, materials same as those conventionally used for a sealant layer for packaging materials may be used and, for example, polyethylene, polypropylene, ethylene-vinyl acetate copolymers, and ionomers can be used. A method for further laminating the sealant layer on the biaxially-stretched layer polyamide film is not particularly limited, but a dry lamination method, an extrusion lamination method, or the like may be employed.

The form of the packaging bag of the present invention is not particularly limited, and examples of the form may include a three-way sealed bag, a four-way sealed bag, a pillow bag, a gusset bag, and a stick bag.

### EXAMPLES

Next, the present invention will be described further in detail with reference to examples, but the present invention should not be limited to the following examples. The film evaluation was carried out by the following measurement methods.

### (1) Impact Strength

For biaxially-stretched layer polyamide films, impact strength was measured under an environment of 23° C. in temperature and 65% in relative humidity by using a film impact tester manufactured by Toyo Seiki Seisaku-sho, Ltd.

### (2) Number of Bending Fatigue Pinholes

Using a Gelbo-Flex tester manufactured by RKC Instrument Inc., number of bending fatigue pinholes of laminated films was measured by the following method.

After a polyester-based adhesive was applied to a biaxially-stretched layer polyamide film produced in examples, a linear low density polyethylene film (L-LDPE film: L4102, manufactured by Toyobo Co., Ltd.) having a thickness of 40 μm was dry-laminated thereon and the laminate was aged under an environment of 40° C. for 3 days to obtain a laminated film. The obtained laminated film was cut into a dimension of 12 inches×8 inches and formed into a cylindrical form 3.5 inches in diameter. One end of the cylindrical film was fixed to the fixed head of the Gelbo-Flex tester, the other end was fixed to the movable head, and the initial holding interval was set to be 7 inches. The film was subjected to bending fatigue, that is, a twist of 440° was applied to the film for the initial stroke of 3.5 inches, and then all the strokes were finished with a linear horizontal movement of 2.5 inches. The bending fatigue was applied to the film 500 times at a speed of 40 times/min, and the number of pinholes generated in the laminated film was counted. The measurement was carried out under an environment of 5° C. The tested film was put on filter paper (No. 50, Advantech Co., Ltd.) with the L-LDPE film as the lower surface and fixed at the 4 corners with Cellotape (registered trade name). An ink (Ink (item # INK-350-blue) manufactured by Pilot Corporation diluted 5 times with pure water) was applied to the tested film and spread all over the film by using a rubber roller. After excess ink was wiped out, the tested film was removed, and the number of dots of the ink deposited on the filter paper was counted.

### (3) Haze

For a biaxially-stretched layer polyamide film, the measurement was carried out according to old JIS-K-7105 by using a direct reading type haze meter manufactured by Toyo Seiki Seisaku-sho, Ltd.

Haze (%)=[Td (diffuse transmittance %)/Tt (total light transmittance %)]×100

### (4) Static Friction Coefficient

The static friction coefficient between easily slipping surfaces of a biaxially-stretched layer polyamide film was measured under an environment of 23° C. and 65% RH according to old JIS-K-7125.

### (5) Breaking Strength

Each biaxially-stretched layer polyamide film, i.e. an object of the measurement was cut into a strip form of 180 mm×15 mm in the flow direction (MD direction) and width direction (TD direction), respectively to obtain a test piece. Tensile breaking strength was measured in the MD direction and in the TD direction under conditions of a tension speed of 200 mm/min and an interval between chucks of 100 mm by using a tensile tester (Autograph (trade name) type AG-5000A, manufactured by Shimadzu Corporation), and the average values in the MD direction and in the TD direction were employed as data.

### (6) Seal Strength

Using the laminated film obtained in (2), the seal strength measurement was carried out according to JIS Z1707. The specific procedure was as follows.

As the heat sealing conditions, seven conditions of the heat sealing temperature and heat sealing time were set: 140° C. for 0.1 seconds, 140° C. for 0.3 seconds, 140° C. for 0.5 seconds, 140° C. for 0.7 seconds, 150° C. for 0.1 seconds, 150° C. for 0.3 seconds, and 150° C. for 0.5 seconds to carry out the measurement. The sealing pressure was set to be 0.2 MPa for all the heat sealing conditions.

Further, regarding the appearance evaluation after the heat sealing, seal layers of a sample were stuck together by a heat sealer and the heat-sealed parts were subjected to appearance evaluation. The appearance evaluation was carried out by evaluating the state of wavy wrinkles in the heat-sealed parts by eye observation. A state with no wrinkle was evaluated as ∘ and a state with significant wrinkles was evaluated as x.

Each sample heat-sealed as described above was subjected to T peel strength measurement in the MD (longitudinal) direction by using a tensile strength tester (trade name: Tensilon UTM, manufactured by Toyo Sokki Co., Ltd.). The tension speed in the measurement was 200 mm/min and the sample width was 15 mm.

### (7) Elastic Modulus

Each biaxially-stretched layer polyamide film, i.e. an object of the measurement was cut into a strip form of 180 mm×15 mm in the flow direction (MD direction) and width direction (TD direction), respectively to obtain a test piece. Elastic modulus was measured in the MD direction and in the TD direction under conditions of a tension speed of 200 mm/min and an interval between chucks of 100 mm by using a tensile tester (Autograph (trade name) type AG-5000A, manufactured by Shimadzu Corporation), and the average values in the MD direction and in the TD direction were employed as the elastic modulus of the film as the object of measurement.

### (8) Heat Shrinkage Rate

Each biaxially-stretched layer polyamide film was cut into a strip form of 250 mm×20 mm in the flow direction (MD direction) and width direction (TD direction), respectively to obtain a test piece. A line of about 150 mm was drawn in the center part of the test piece. This sample was left in an atmosphere of 23° C. and 50% RH for 24 hours, and the length of the standard line was measured. The measured length was defined as the length F before heat treatment. After the sample was hung in a hot air drier kept at 160° C., heated for 10 minutes, and thereafter left in an atmosphere of 23° C. and 50% RH for 20 minutes, the length of the standard line was measured as the length G after heat treatment.

The heat shrinkage rate was calculated according to [(F−G)/F]×100(%).

In the above-mentioned manner, the shrinkage factor was measured in the MD direction and in the TD direction with the number of the sample being n=3, and the average value was defined as the heat shrinkage rate.

### Example 1

An unstretched sheet with the following configuration was obtained by using co-extrusion T-die equipment. The unstretched sheet having a B layer/A layer configuration had a total thickness of 110 μm and a thickness rate of the A layer in the total thickness of 88%.

The composition constituting the A layer was a mixed polymer composition containing 87 parts by weight of nylon 6 (T814, manufactured by Toyobo Co., Ltd.), 10 parts by weight of an aliphatic copolyamide containing nylon 6 and nylon 12 (7034B, manufactured by Ube Industries, Ltd.), 3.0 parts by weight of a polyamide-based elastomer containing nylon 12 as a polyamide component (PEBAX 4033SN01, manufactured by Arkema), and further 0.1 parts by weight of a phenolic antioxidant (Irganox 1010, manufactured by Ciba Specialty Chemicals Ltd.).

The composition constituting the B layer was a polymer composition containing 96.85 parts by weight of nylon 6 (T814, manufactured by Toyobo Co., Ltd.), 3.0 parts by weight of a polyamide-based elastomer (PEBAX 4033SN01, manufactured by Arkema), 0.08 parts by weight of silica particles having a fine pore volume of 0.6 to 1.0 ml/g, 0.5 parts by weight of silica particles having a fine pore volume of 1.1 to 1.6 ml/g, and 0.15 parts by weight of an aliphatic acid amide.

The obtained unstretched sheet was stretched 3.4 times in the vertical direction and successively stretched 4.0 times in the transverse direction, and then subjected to a heat treatment at 202° C. for 10 seconds in a heat fixation zone to obtain a biaxially-stretched layer polyamide film having a thickness of 8 μm. Further, the B layer surface on which a linear low density polyethylene film (L-LDPE film: L4102, manufactured by Toyobo Co., Ltd.) having a thickness of 40 μm was to be dry-laminated was subjected to a corona discharge treatment. Haze, static friction coefficient, breaking strength, impact strength, number of bending fatigue pinholes, elastic modulus, and heat shrinkage rate of the resulting biaxially-stretched layer polyamide film were measured. The results are shown in Table 1 together with detailed layer configurations. Further, after a polyester-based adhesive was applied to the biaxially-stretched layer polyamide film, a linear low density polyethylene film (L-LDPE film: L4102, manufactured by Toyobo Co., Ltd.) having a thickness of 40 μm was dry-laminated thereon and the laminate was aged under an environment of 40° C. for 3 days to obtain a laminated film. The number of bending fatigue pinholes and seal strength of the resulting laminated film were measured. The results are shown in Table 1 together with detailed layer configurations. The film was found to be excellent in pinhole resistance and bending resistance. Further, since the film had sufficient heat seal strength by being heat-sealed under conditions of a heat sealing temperature of 140° C. or 150° C. for a heat sealing time of 0.5 seconds or 0.1 seconds, and also had good appearance after the heat sealing, the film satisfied both of high heat seal strength and appearance properties even in the case of being used for automatic filling at high speed.

### Example 2

An unstretched sheet with the following configuration was obtained by using co-extrusion T-die equipment for 3-layers of 2 types. The unstretched sheet having a B layer/A layer/B layer configuration had a total thickness of 110 μm and a thickness rate of the A layer in the total thickness of 75%.

The composition constituting the A layer was a mixed polymer composition containing 87 parts by weight of nylon 6 (T814, manufactured by Toyobo Co., Ltd.), 5 parts by weight of an aliphatic copolyamide containing nylon 6 and nylon 12 (7034B, manufactured by Ube Industries, Ltd.), 6.0 parts by weight of a polyamide-based elastomer containing nylon 12 as a polyamide component (PEBAX 4033SN01, manufactured by Arkema), and further 0.1 parts by weight of a phenolic antioxidant (Irganox 1010, manufactured by Ciba Specialty Chemicals Ltd.).

The composition constituting the B layer was a polymer composition containing 93.85 parts by weight of nylon 6 (T814, manufactured by Toyobo Co., Ltd.), 6.0 parts by weight of a polyamide-based elastomer (PEBAX 4033SN01, manufactured by Arkema), 0.08 parts by weight of silica particles having a fine pore volume of 0.6 to 1.0 ml/g, 0.5 parts by weight of silica particles having a fine pore volume of 1.1 to 1.6 ml/g, and 0.15 parts by weight of an aliphatic acid amide.

The obtained unstretched sheet was stretched 3.4 times in the vertical direction and successively stretched 4.0 times in the transverse direction, and then subjected to a heat treatment at 202° C. for 10 seconds in a heat fixation zone to obtain a biaxially-stretched layer polyamide film having a thickness of 8 μm. Further, the B layer surface on which a linear low density polyethylene film (L-LDPE film: L4102, manufactured by Toyobo Co., Ltd.) having a thickness of 40 μm was to be dry-laminated was subjected to a corona discharge treatment. Haze, static friction coefficient, breaking strength, impact strength, number of bending fatigue pinholes, elastic modulus, and heat shrinkage rate of the resulting biaxially-stretched layer polyamide film were measured. The results are shown in Table 1 together with detailed layer configurations. Further, after a polyester-based adhesive was applied to the biaxially-stretched layer polyamide film, a linear low density polyethylene film (L-LDPE film: L4102, manufactured by Toyobo Co., Ltd.) having a thickness of 40 μm was dry-laminated thereon and the laminate was aged under an environment of 40° C. for 3 days to obtain a laminated film. The number of bending fatigue pinholes and seal strength of the resulting laminated film were measured. The results are shown in Table 1 together with detailed layer configurations. The film was found to be excellent in pinhole resistance and bending resistance. Further, since the film had sufficient heat seal strength by being heat-sealed under conditions of a heat sealing temperature of 140° C. or 150° C. for a heat sealing time of 0.5 seconds or 0.1 seconds, and also had good appearance after the heat sealing, similarly to the film of Example 1, the film satisfied both of high heat seal strength and appearance properties even in the case of being used for automatic filling at high speed.

### Comparative Example 1

An unstretched sheet with the following configuration was obtained by using co-extrusion T-die equipment. The unstretched sheet having a B layer/A layer configuration had a total thickness of 110 μm and a thickness rate of the A layer in the total thickness of 92%.

The composition constituting the A layer was a mixed polymer composition containing 97 parts by weight of nylon 6 (T814, manufactured by Toyobo Co., Ltd.), 3.0 parts by weight of a polyamide-based elastomer (PEBAX 4033SN01, manufactured by Arkema) containing nylon 12 as a polyamide component, and further 0.1 parts by weight of a phenolic antioxidant (Irganox 1010, manufactured by Ciba Specialty Chemicals Ltd.).

The composition constituting the B layer was a polymer composition containing 96.85 parts by weight of nylon 6 (T814, manufactured by Toyobo Co., Ltd.), 3.0 parts by weight of a polyamide-based elastomer (PEBAX 4033SN01, manufactured by Arkema), 0.4 parts by weight of silica particles having a fine pore volume of 1.1 to 1.6 ml/g, and 0.15 parts by weight of an aliphatic acid amide.

The obtained unstretched sheet was stretched 3.4 times in the vertical direction and successively stretched 4.0 times in the transverse direction, and then subjected to a heat treatment at 215° C. for 10 seconds in a heat fixation zone to obtain a biaxially-stretched layer polyamide film having a thickness of 8 μm. Further, the B layer surface on which a linear low density polyethylene film (L-LDPE film: L4102, manufactured by Toyobo Co., Ltd.) having a thickness of 40 μm was to be dry-laminated was subjected to a corona discharge treatment. Haze, static friction coefficient, breaking strength, impact strength, number of bending fatigue pinholes, elastic modulus, and heat shrinkage rate of the resulting biaxially-stretched layer polyamide film were measured. The results are shown in Table 1 together with detailed layer configurations. Since the temperature of the heat fixation zone was as high as 215° C., crystallization of the film proceeded beyond necessity, and bending fatigue pinhole resistance and elastic modulus of the film were inferior.

### Comparative Example 2

An unstretched sheet with the following configuration was obtained by using co-extrusion T-die equipment. The unstretched sheet having a B layer/A layer configuration had a total thickness of 110 μm and a thickness rate of the A layer in the total thickness of 93%.

The composition constituting the A layer was a mixed polymer composition containing 97 parts by weight of nylon 6 (T814, manufactured by Toyobo Co., Ltd.), 3.0 parts by weight of a polyamide-based elastomer (PEBAX 4033SN01, manufactured by Arkema) containing nylon 12 as a polyamide component, and further 0.1 parts by weight of a phenolic antioxidant (Irganox 1010, manufactured by Ciba Specialty Chemicals Ltd.).

The composition constituting the B layer was a polymer composition containing 96.85 parts by weight of nylon 6 (T814, manufactured by Toyobo Co., Ltd.), 3.0 parts by weight of a polyamide-based elastomer (PEBAX 4033SN01, manufactured by Arkema), 0.5 parts by weight of silica particles having a fine pore volume of 1.1 to 1.6 ml/g, and 0.15 parts by weight of an aliphatic acid amide.

The obtained unstretched sheet was stretched 3.4 times in the vertical direction and successively stretched 4.0 times in the transverse direction, and then subjected to a heat treatment at 215° C. for 10 seconds in a heat fixation zone to obtain a biaxially-stretched layer polyamide film having a thickness of 8 μm. Further, the B layer surface on which a linear low density polyethylene film (L-LDPE film: L4102, manufactured by Toyobo Co., Ltd.) having a thickness of 40 μm was to be dry-laminated was subjected to a corona discharge treatment. Haze, static friction coefficient, breaking strength, impact strength, number of bending fatigue pinholes, elastic modulus, and heat shrinkage rate of the resulting biaxially-stretched layer polyamide film were measured. The results are shown in Table 1 together with detailed layer configurations. Since the temperature of the heat fixation zone was as high as 215° C., crystallization of the film proceeded beyond necessity, and bending fatigue pinhole resistance and elastic modulus of the film were inferior similarly to those of Comparative Example 1.

### Comparative Example 3

An unstretched sheet with the following configuration was obtained by using co-extrusion T-die equipment for 3-layers of 2 types. The unstretched sheet having a B layer/A layer/B layer configuration had a total thickness of 130 μm and a thickness rate of A layer in the total thickness of 75%.

The composition constituting the A layer was a mixed polymer composition containing 87 parts by weight of nylon 6 (T814, manufactured by Toyobo Co., Ltd.), 5 parts by weight of an aliphatic copolyamide containing nylon 6 and nylon 12 (7034B, manufactured by Ube Industries, Ltd.), 6.0 parts by weight of a polyamide-based elastomer containing nylon 12 as a polyamide component (PEBAX 4033SN01, manufactured by Arkema), and further 0.1 parts by weight of a phenolic antioxidant (Irganox 1010, manufactured by Ciba Specialty Chemicals Ltd.).

The composition constituting the B layer was a polymer composition containing 93.85 parts by weight of nylon 6 (T814, manufactured by Toyobo Co., Ltd.), 6.0 parts by weight of a polyamide-based elastomer (PEBAX 4033SN01, manufactured by Arkema), 0.08 parts by weight of silica particles having a fine pore volume of 0.6 to 1.0 ml/g, 0.5 parts by weight of silica particles having a fine pore volume of 1.1 to 1.6 ml/g, and 0.15 parts by weight of an aliphatic acid amide.

The obtained unstretched sheet was stretched 3.4 times in the vertical direction and successively stretched 4.0 times in the transverse direction, and then subjected to a heat treatment at 202° C. for 10 seconds in a heat fixation zone to obtain a biaxially-stretched layer polyamide film having a thickness of 8 μm. Further, the B layer surface on which a linear low density polyethylene film (L-LDPE film: L4102, manufactured by Toyobo Co., Ltd.) having a thickness of 40 μm was to be dry-laminated was subjected to a corona discharge treatment. Haze, static friction coefficient, breaking strength, impact strength, number of bending fatigue pinholes, elastic modulus, and heat shrinkage rate of the resulting biaxially-stretched layer polyamide film were measured. The results are shown in Table 1 together with detailed layer configurations. Further, after a polyester-based adhesive was applied to the biaxially-stretched layer polyamide film, a linear low density polyethylene film (L-LDPE film: L4102, manufactured by Toyobo Co., Ltd.) having a thickness of 40 μm was dry-laminated thereon and the laminate was aged under an environment of 40° C. for 3 days to obtain a laminated film. The number of bending fatigue pinholes and seal strength of the resulting laminated film were measured. There was no heat sealing condition for giving sufficient heat seal strength and good appearance after heat sealing, and the resulting film failed to satisfy both high heat seal strength and appearance properties when used for automatic filling at a high speed.

TABLE 1

| | | | | | | Comparative | Comparative | Comparative |
|---|---|---|---|---|---|---|---|---|
| | | | | Example 1 | Example 2 | Example 1 | Example 2 | Example 3 |
| Configuration | Nylon 6 | | wt. % | 87 | 87 | 97 | 97 | 87 |
| of A layer | Nylon 6/12 copolymer | | wt. % | 10 | 5 | 0 | 0 | 5 |
| | Polyamide-based Elastomers | | wt. % | 3 | 6 | 3 | 3 | 6 |
| | Phenolic Antioxidant | | wt. % | 0.1 | 0.1 | 0.1 | 0.1 | 0.1 |
| Configuration | Nylon 6 | | wt. % | 96.85 | 93.85 | 96.85 | 96.85 | 93.85 |
| of B layer | Polyamide-based Elastomers | | wt. % | 3 | 6 | 3 | 3 | 6 |
| | Silica Particles | Fine Pore Volume (0.6~1.0 ml/g) | wt. % | 0.08 | 0.08 | 0 | 0 | 0.08 |
| | | Fine Pore Volume (1.1~1.6 ml/g) | wt. % | 0.5 | 0.5 | 0.4 | 0.5 | 0.5 |

| | | | | | | |
|---|---|---|---|---|---|---|
| Aliphatic Acid Amide | wt. % | 0.15 | 0.15 | 0.15 | 0.15 | 0.15 |

| Laminated Structure | | | | A/B | B/A/B | A/B | A/B | B/A/B |
|---|---|---|---|---|---|---|---|---|
| Thickness rate of the A layer | | | % | 88 | 75 | 92 | 93 | 75 |
| Heat Fixation Temperature | | | ° C. | 202 | 202 | 215 | 215 | 202 |
| Total Thickness | | | 82 m | 8 | 8 | 8 | 8 | 10 |
| Haze | | | % | 1.9 | 1.6 | 1.1 | 1.5 | 1.9 |
| Static Friction Coefficient | | | μd | 0.5 | 0.6 | 1.2 | 0.9 | 0.6 |
| Impact Strength | | | J | 0.57 | 0.55 | 0.53 | 0.59 | 0.73 |
| Number of Bending Fatigue Pinholes | | | number | 1 | 1 | 6 | 3 | 1 |
| Elastic Modulus | | | GPa | 2.1 | 2.0 | 2.3 | 2.3 | 2.0 |
| Sealing Temperature | Sealing Time | Seal Strength | N/15 mm | 12.9 | 12.5 | 12.1 | 11.8 | 9.0 |
| 140° C. | 0.1 seconds | Appearance After Sealing | — | ◯ | ◯ | ◯ | ◯ | ◯ |
| Sealing Temperature | Sealing Time | Seal Strength | N/15 mm | 18.3 | 18.9 | 17.0 | 16.5 | 12.3 |
| 140° C. | 0.3 seconds | Appearance After Sealing | — | ◯ | ◯ | ◯ | ◯ | ◯ |
| Sealing Temperature | Sealing Time | Seal Strength | N/15 mm | 23.8 | 23.4 | 22.1 | 21.0 | 16.9 |
| 140° C. | 0.5 seconds | Appearance After Sealing | — | ◯ | ◯ | ◯ | ◯ | ◯ |
| Sealing Temperature | Sealing Time | Seal Strength | N/15 mm | 29.1 | 30.2 | 27.0 | 28.8 | 20.1 |
| 140° C. | 0.7 seconds | Appearance After Sealing | — | X | X | X | X | X |
| Sealing Temperature | Sealing Time | Seal Strength | N/15 mm | 31.0 | 31.2 | 31.5 | 31.1 | 21.9 |
| 150° C. | 0.1 seconds | Appearance After Sealing | — | ◯ | ◯ | ◯ | ◯ | ◯ |
| Sealing Temperature | Sealing Time | Seal Strength | N/15 mm | 33.2 | 33.6 | 27.3 | 26.9 | 21.4 |
| 150° C. | 0.3 seconds | Appearance After Sealing | — | X | X | X | X | X |
| Sealing Temperature | Sealing Time | Seal Strength | N/15 mm | 35.2 | 34.9 | 32.7 | 31.8 | 23.0 |
| 150° C. | 0.5 seconds | Appearance After Sealing | — | X | X | X | X | X |

| Heat Shrinkage Rate | Flow Direction | % | 2.9 | 3.0 | 1.0 | 1.0 | 2.8 |
|---|---|---|---|---|---|---|---|
| | Width Direction | % | 3.5 | 3.6 | 1.1 | 1.2 | 3.6 |
| Heat Shrinkage Rate In Width Direction/ | | — | 1.2 | 1.2 | 1.1 | 1.2 | 1.3 |
| Heat Shrinkage Rate In Flow Direction | | | | | | | |
| Breaking Strength | Flow Direction | N/15 mm | 29 | 33 | 29 | 30 | 40 |
| | Width Direction | N/15 mm | 36 | 39 | 36 | 36 | 49 |

As described above, the biaxially-stretched layer polyamide film of the present invention is described with reference to a plurality of examples, but the present invention should not be limited to the above-mentioned configurations described in the examples, and the configurations may be properly changed by adequately combining the configurations described in the examples without departing from the true spirit and scope of the invention.

### INDUSTRIAL APPLICABILITY

A biaxially-stretched layer polyamide film of the present invention can be preferably used for packaging material applications for food packaging or the like since the film has properties that it is excellent in impact resistance and bending fatigue resistance. Particularly, the film can be extremely advantageously used when a thinned configuration is required.

1. A biaxially-stretched layer polyamide film having a heat shrinkage rate of 1.5% to 4.0% in a vertical direction and a heat shrinkage rate of 2.1 to 4.5% in a transverse direction when kept under dry heating at 160° C. for 10 minutes, a film thickness of less than 9 μm, and an elastic modulus of not more than 2.2 GPa.

2. The biaxially-stretched layer polyamide film according to claim 1, wherein a value calculated by dividing a heat shrinkage rate in a film width direction by a heat shrinkage rate in a film flow direction when the film is kept under dry heating at 160° C. for 10 minutes is 1.0 to 1.4.

3. The biaxially-stretched layer polyamide film according to claim 1, comprising: an A layer of a mixed polymer containing 97 to 70 wt. % of an aliphatic homopolyamide, 3 to 20 wt. % of an aliphatic copolyamide, and 0 to 10 wt. % of a thermoplastic elastomer, and a B layer of a mixed polymer containing 99.5 to 90 wt. % of an aliphatic homopolyamide and 0.5 to 10.0 wt. % of a thermoplastic elastomer, the B layer being layered on at least one surface of the A layer.

4. The biaxially-stretched layer polyamide film according to claim 1, wherein the thermoplastic elastomer constituting the A layer is at least one elastomer selected from the group consisting of polyamide-based elastomers, polyolefin-based elastomers, and ionomers.

5. The biaxially-stretched layer polyamide film according to claim 1, wherein the B layer has a thickness of not less than 1 μm.

6. The biaxially-stretched layer polyamide film according to claim 1, wherein the film has an impact strength of not less than 0.6 J/10 μm, a number of bending fatigue pinholes at 5° C. of not more than 5, and a breaking strength of not less than 200 MPa.

7. The biaxially-stretched layer polyamide film according to claim 1, wherein the B layer contains 0.005 to 0.5 wt. % of inorganic fine particles having a fine pore volume of 0.6 to 1.0 ml/g and 0.01 to 2.0 wt. % of inorganic fine particles having a fine pore volume of 1.1 to 1.6 ml/g, and the inorganic fine particles have an average particle diameter of 0.5 to 5.0 μm.

8. The biaxially-stretched layer polyamide film according to claim 1, wherein the A layer and/or the B layer contains 0.01 to 0.40 wt. % of an aliphatic acid amide and/or an aliphatic acid bisamide.

9. The biaxially-stretched layer polyamide film according to claim 1, wherein the film has a static friction coefficient between easily slipping surfaces of the film at 23° C. and 65% RH of not more than 0.90.

10. A packaging bag, comprising the biaxially-stretched layer polyamide film according to claim 1 with a B layer as an outermost layer.

11. The biaxially-stretched layer polyamide film according to claim 2, comprising: an A layer of a mixed polymer containing 97 to 70 wt. % of an aliphatic homopolyamide, 3 to 20 wt. % of an aliphatic copolyamide, and 0 to 10 wt. % of a thermoplastic elastomer, and a B layer of a mixed polymer containing 99.5 to 90 wt. % of an aliphatic homopolyamide and 0.5 to 10.0 wt. % of a thermoplastic elastomer, the B layer being layered on at least one surface of the A layer.

12. The biaxially-stretched layer polyamide film according to claim 11, wherein the thermoplastic elastomer constituting the A layer is at least one elastomer selected from the group consisting of polyamide-based elastomers, polyolefin-based elastomers, and ionomers.

13. The biaxially-stretched layer polyamide film according to claim 11, wherein the B layer has a thickness of not less than 1 μm.

14. The biaxially-stretched layer polyamide film according to claim 11, wherein the film has an impact strength of not less than 0.6 J/10 μm, a number of bending fatigue pinholes at 5° C. of not more than 5, and a breaking strength of not less than 200 MPa.

15. The biaxially-stretched layer polyamide film according to claim 11, wherein the B layer contains 0.005 to 0.5 wt. % of inorganic fine particles having a fine pore volume of 0.6 to 1.0 ml/g and 0.01 to 2.0 wt. % of inorganic fine particles having a fine pore volume of 1.1 to 1.6 ml/g, and the inorganic fine particles have an average particle diameter of 0.5 to 5.0 μm.

16. The biaxially-stretched layer polyamide film according to claim 11, wherein the A layer and/or the B layer contains 0.01 to 0.40 wt. % of an aliphatic acid amide and/or an aliphatic acid bisamide.

17. The biaxially-stretched layer polyamide film according to claim 11, wherein the film has a static friction coefficient between easily slipping surfaces of the film at 23° C. and 65% RH of not more than 0.90.
